(19) United States
(12) Patent Application Publication
(10) Pub. No.: US 2005/0240965 A1
(43) Pub. Date: Oct. 27, 2005

(54) Interactive media program guide

(76) Inventors: David J. Watson, Valencia, CA (US); Dale Herigstad, Hollywood, CA (US); Stephan Fopeano, Los Angeles, CA (US); Matthew James Mulder, Seattle, WA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/109,286

(22) Filed: Apr. 18, 2005

Related U.S. Application Data
(60) Provisional application No. 60/564,441, filed on Apr. 21, 2004.

(51) Int. Cl. H04N 5/445; G06F 13/00; H04N 7/173

(52) U.S. Cl. 725/45; 725/44; 725/52; 725/37

(57) ABSTRACT

An interactive media programming guide for displaying a plurality of pictorial icons to a viewer indicating to the viewer, orally or visually, using well known icons, what programming content is on at the time of viewing, upcoming, etc., that may be of interest to the viewer.

### CROSS-REFERENCE TO RELATED APPLICATION

This application claims the benefit of provisional application Ser. No. 60/564,441, filed Apr. 21, 2004, the contents of which are incorporated by reference herein in their entirety.

### BACKGROUND

1. Field

The method and system generally relates to media programming, and more specifically, to a method and system for interacting with a guide to media programming.

2. General Background and State of the Art

Viewers of media content presented on television or a computer screen or other media display device are now able to choose from a selection of virtually hundreds of different channels. In order to help users determine the programming content associated with a given channel at a given time, many content providers provide the user with a programming guide that displays the content for a given channel. Some on-screen television program guides display current programming to the user.

A number of problems exist with the current programming guides that are provided by content service providers. Many users store a select few channels in memory as “favorites” in order to avoid having to look through the hundreds of different channels displayed in the programming guide. As a result, these users do not get the benefit of viewing some content that they may find interesting but does not reside in the channels in their “favorites” category. They may be totally unaware of certain such programming.

Another problem with the existing programming guide is complexity. A user must press a lot of buttons in order to maneuver through the existing programming guide. Further, the use of such buttons is not entirely intuitive. Accordingly, the elderly, handicapped, and children have difficulty using the existing programming guide.

One other difficulty with the existing programming guide is its limited application. For instance, the existing programming guide cannot be used with video on demand content or other content that does not have a time factor.

### SUMMARY

It is an object of this invention to provide an interactive programming guide for navigating programming, such as media programming depicted on a television or computer screen or other media display device.

It is a further object of this invention to expose television viewers to certain types of programming that may be of interest to the viewer.

It is still another object of this invention to provide a guide to on-the-air television programming while enabling the promotion of other available programming.

It is still another object of this invention to guide the viewer's interest to desired programming even during commercial breaks or the like.

It is also an object of this invention to direct viewers toward media content geared by the content provider to the viewer according to his or her age.

It is a further object of this invention to direct viewers toward television programs of interest to the viewer based on prior viewing habits of the viewer.

It is still further an object of this invention to alter the viewing habits of a television viewer by guiding the viewer toward programming of a particular type of interest to the viewer.

It is a further object of this invention to develop interactive or personalization features of interest to a viewer to direct the viewer's television viewing toward particular programming, or in a particular direction.

These and other objects are preferably accomplished by providing an interactive media programming method and system for viewers that is depicted on a television or computer or other media display device.

### DRAWINGS

The above-mentioned features and objects of the present disclosure will become more apparent with reference to the following description taken in conjunction with the accompanying drawings wherein like reference numerals denote like elements and in which:

FIG. 1 is a pictorial representation of a classroom or the like as depicted on a television screen;

FIG. 2 is a pictorial illustration of a scene from a television program displaying a pop-up character in the lower left corner;

FIG. 3 is a pictorial illustration of the pop-up character in FIG. 2 promoting a particular television program;

FIG. 4 is a pictorial illustration of the television episode being promoted in the upper left corner, a Clay character being shown in the frame to promote the selected episode by both dialogue (through the character) and text; and

FIG. 5 is a pictorial illustration similar to FIG. 4 but displaying more information for older viewers.

### DETAILED DESCRIPTION

As particularly contemplated in the present invention, the interactive guide navigation concepts may be age-specific. For example, one category may be as follows:

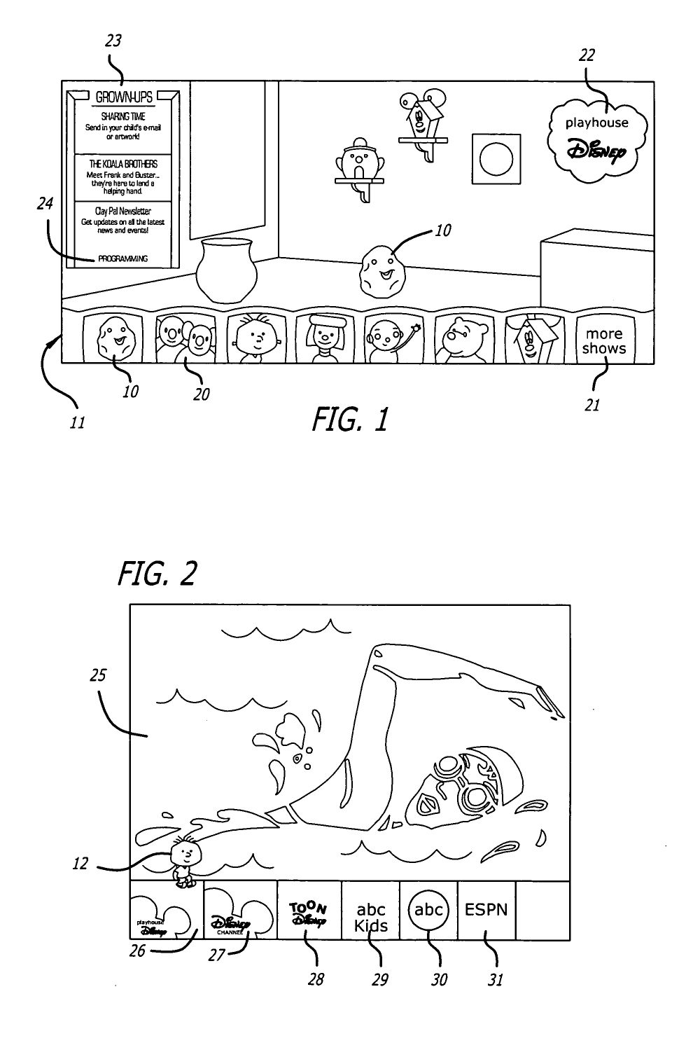

Referring to FIG. 1, for pre-readers, such as young children, a text-based grid may not be appropriate and thus, as seen, the navigation for children may be based on pictorial icons from the child's favorite shows placed in the context of a familiar scene, like a playroom, bedroom, school room, or similar. The view could be two-dimensional or three-dimensional depending on the capabilities of the consumer's hardware.

A navigation interface such as shown in FIG. 1 allows the child to find his or her favorite programming. In some cases, the program may not be airing live, but may be available on demand. This view could change to focus the child on the program which is airing live, for example, by bringing the icons for the current show to the forefront, or making them more prominent in size.

Characters from the shows, or the interstitial “host” character, such as the Clay character 10, could provide guidance to the viewer by vocalizing recommendations for new programs or new episodes, or by visually highlighting the pictorial icons and telling children about what's on the current episode.

Characters could help children visually re-arrange their view, making their favorite shows more prominent, or perhaps ordering a sequence of programs for viewing, mixing live and on-demand content.

A pop-up favorites bar 11 would allow viewers to easily move between their favorite channels. Network groups such as ABC could create predefined favorite groups for easy selection by children or parents. (For parents, this may be a simple form of parental control.) That is, each icon along bar 11, such as icon 20, (the “host” Clay character 10 being disposed at the beginning of bar 11), may represent a particular “favorite” channel. The last icon 21 along bar 20 may provide access to more channels. The scene depicted on screen in FIG. 1 may identify the source of the program guide, e.g., Playhouse Disney, at plaque 22, along with other objects normally associated with a child's playroom, such as photographs, toys, objects from well known programs, etc. A placard 23 may be provided as a guide to parents terminating at bottom with a “Programming” interactive button representation. Such a guide may alert the parents to programming and other interactive activities that their child may be interested in.

FIG. 2 illustrates how a favorite character 12 could serve as a guide or barker for content that the network wishes to promote. For example, alerting the user that Stanley's show (the host Clay character 10) is coming on shortly. This could be particularly useful if the child was currently viewing on-demand content, such as scene 25. Character 12 pops up and orally or visually alerts the viewer to upcoming programs as depicted by icons 26 through 31, for example.

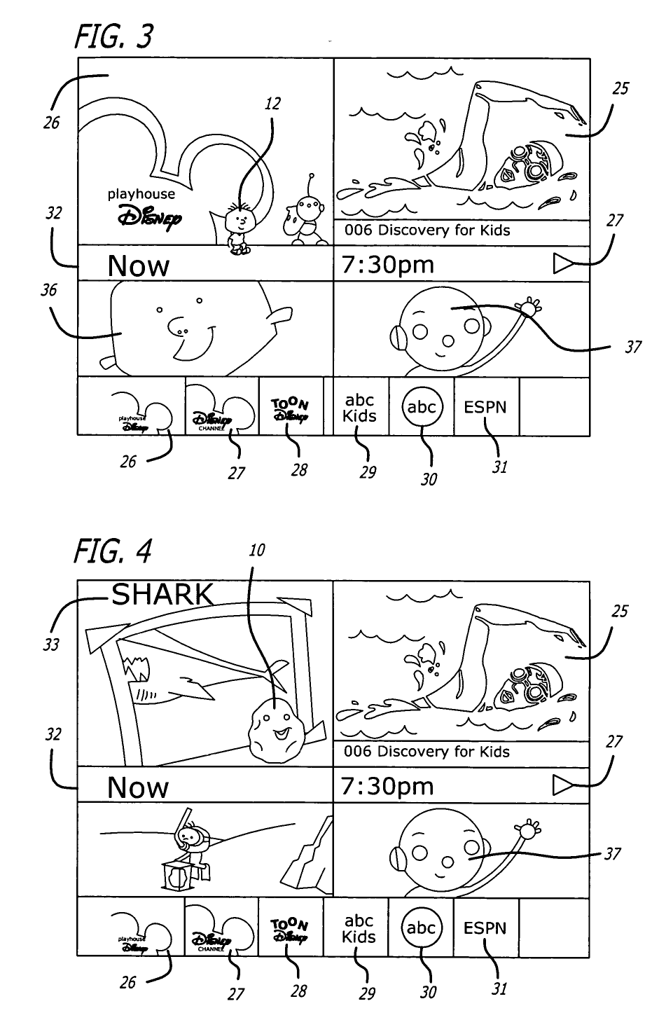

For children, it is beneficial to simplify the visual presentation of show and schedule information. Still remaining in the current grid format of FIG. 2, and activating one of the icons, the view in FIG. 3 opens up that grid to make the cells larger, display fewer channels, and fewer time slots. Displaying less information focuses on making the interface more digestible for children, and focuses them on what they're most interested in: only their favorite channels/shows, and what's on now and what's next (not in an hour or two). Note that the Stanley character 12 is still predominant and the time bar 32 advises the viewer what is on now (or immediately upcoming) on a particular channel. That is, Stanley is on Now, as indicated by character icon 36, and is upcoming at 7:30 PM as indicated by character 37. The currently viewed channel 25 is located in the upper right corner of the screen, an everyday programming (what is on Now) on a particular channel is depicted in screen 26 in the upper left corner screen. Clicking or activating arrow 27 will take the user to the programs after 7:30 PM.

Opening up the display offers the network the opportunity to promote the channel and show 26, as shown in FIG. 3, in the upper left corner. By relying on branding elements, which are familiar to children, the promotion need not use large amounts of text.

FIG. 4 illustrates how the promotional space 33 (upper left) can show detailed explanations of the content of the episode (in this example, Stanley is about sharks). The host Clay character 10 in the frame shows how any host character can present the promotional information in dialogue rather than text.

Parents could possibly customize this view further by limiting the channels that appear, or by creating a timeline, represented by icons 26 to 31 of programming (a custom channel in effect), which could also be locked, creating a parental control mechanism. This timeline could include both live and on-demand content.

For older children, who can read, and who can absorb and process more information than pre-schoolers, the same concept can be expanded. The representations of the shows and channels are still pictorial, but there may be more information on the screen.

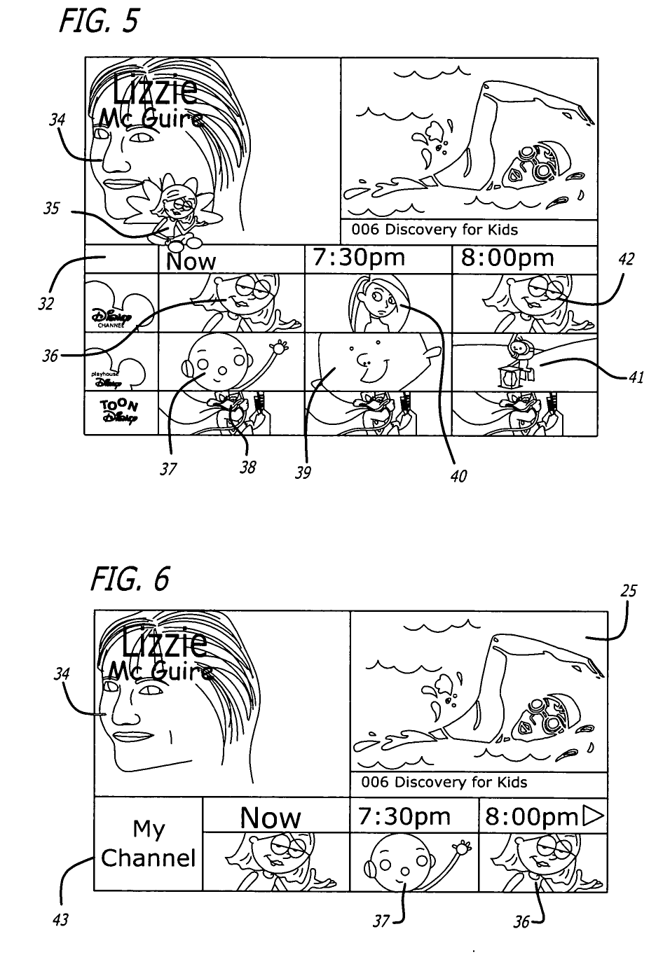

This is illustrated in FIG. 5 where for example, the program Lizzie McGuire is advertised in the upper left panel 34 introduced by a pop-up cartoon character 35 of Lizzie McGuire indicated the program is on NOW on the Disney Channel indicated by a close up view 36 of pop-up character 35. The Rollie Pollie Ollie character 37 indicates that this character is on Playhouse Disney NOW, and the Bird character 38 indicates that this character is on Toon Disney NOW. This show carries over to 7:30 PM and 8:00 PM whereas Stanley character 39 comes back on at 7:30 PM on Playhouse House while the Kim Impossible character 40 indicates that this character is also on at 7:30 PM on the Disney Channel. The Stanley Character 39 carries over to 8:00 PM as indicated by character 41 whereas Lizzie McGuire comes back to the Disney Channel at 8:00 PM.

This expanded grid in FIG. 5 could allow for personalization features, such as the ability to create a viewing timeline which would mix live and -on demand content. This is shown in FIG. 6 wherein like numerals refer to the illustrated screen of FIG. 5. Thus, the MY CHANNEL bar 38 has been personalized to show the Lizzie McGuire program NOW, the program at 7:30 PM and back to the Lizzie McGuire program at 8:00 PM. Viewers could drag and drop programming into the timeline grid 38 which would essentially be a separate channel, referred to as My Channel.

The interactive programming system can be used in conjunction with general television programs or video on demand or other games and activities that can be performed on the media display device. Although a television screen has been used as an example, the screen could be a computer monitor or other media display device. In fact, some computers today bring television programming to the computer.

The display could be on the screen of a cellular phone, personal video player or on a personal digital assistant. A conventional television type remote control, with buttons or other operating means, may be used to select various portions of the display.

It can be seen that an interactive programming method and system is disclosed for navigating the ever widening expanding universe of content which may be displayed on a television screen, computer screen, etc.

The interactive programming guide includes a menu display module that displays a menu of a plurality of pictorial icons, wherein certain ones of the plurality of pictorial icons are associated with programming contents. The reception module receives a menu selection from the user and a programming content selection module displays on a display the programming content associated with the menu selection.

The programming content may be television content, video on demand content, games, e-books, information about shopping locations, or information about various types of products.

The display may be a television screen, a computer monitor, a screen on a cellular phone, a screen on a personal digital assistant, etc. At least one pictorial icon displayed on the menu would be one that is not associated with the programming content and at least one of the plurality of the pictorial icons may be a graphical image of a character or scene or item from programming content associated with the at least one of the plurality of the pictorial icons.

The pictorial icons may be two or three dimensional graphical images and a pictorial icon sizing module may be provided that that changes the size of the at least one of the plurality of the pictorial icons with at least another one of the plurality of the pictorial icons. Such pictorial icon sizing module may display a pictorial icon that is larger than at least one of the plurality of pictorial icons to indicate that the associated programming content is video on demand or a predetermined favorite, or live programming content.

The pictorial icon may include a module that changes the shape or color of the at least one of the plurality of the pictorial icons with at least another one of the plurality of the pictorial icons. Such module may display at least one of the plurality of the pictorial icons as being in the forefront of the display compared with at least another one of the plurality of the pictorial icons.

The interactive programming guide may include at least one button operably connected to the display that the user presses in order to make the menu selection and/or a remote control that transmits a user input of the menu selection to the display.

The interactive programming guide may include a menu display module that displays a menu of a plurality of pictorial icons, wherein each of the plurality of pictorial icons is associated with one of the plurality of pictorial icons and a reception module is provided that receives a menu selection from the user. A programming content selection module displays on a display the programming content associated with the menu selection. The information request answer module may be a voice based response system.

The menu display module may display a plurality of user selectable programs including at least one menu bar displaying available channels with pictorial icons associated with programs playing on said channels; and displaying a favorite character of a viewer to promote an upcoming program of interest to the viewer or to help a viewer who cannot read to learn what content is available, both now playing and on demand.

The favorite character may be as a pop-up on the menu display module and an audible message may be associated with the favorite character to vocally announce an upcoming program. The favorite character may be displayed as sitting on top of a menu bar. The menu display module may include at least one menu bar displaying available channels, the guide presenting the programs and the menu bar in a setting familiar to the user, such as his or her bedroom, classroom, etc.

The menu display module may include at least one menu bar displaying available channels with pictorial icons associated with programs playing on the channels, and displaying a character to promote an upcoming program of interest to the viewer or to help a viewer who cannot read learn what content is available, both now and playing on demand. The icon promoting the program may be a character associated with one of the programs and such may orally promote the program. Text messages may be associated with the character to promote the program.

The programming guide may include network promotional space on the display displaying information to the user in the form of text, graphics, video and/or audio and such information may be based on the user's previous sections. Such viewer may be the user or a parent or guardian. The information presented may include programming that the network wishes to promote.

Although particular embodiments of the inventive concepts has been disclosed, it is to be understood that other embodiments may be utilized and structural and functional changes may be made without departing from the respective scope of the present invention.

1. An interactive programming guide, comprising:
a menu display module that displays a menu of a plurality of pictorial icons, wherein certain ones of the plurality of pictorial icons are associated with programming content;
a reception module that receives a menu selection from the user; and
a programming content selection module that displays on a display the programming content associated with the menu selection.

2. The interactive programming guide of claim 1, wherein the programming content is television content.

3. The interactive programming guide of claim 1, wherein the programming content is video on demand content.

4. The interactive programming guide of claim 1, wherein the programming content are games.

5. The interactive programming guide of claim 1, wherein the programming content are e-books.

6. The interactive programming guide of claim 1, wherein the programming content is information about shopping locations.

7. The interactive programming guide of claim 1, wherein the programming content is information about various types of products.

8. The interactive programming guide of claim 1, wherein the display is a television screen.

9. The interactive programming guide of claim 1, wherein the display is a computer monitor.

10. The interactive programming guide of claim 1, wherein the display is a screen on a cellular phone.

11. The interactive programming guide of claim 1, wherein the display is a screen on a personal digital assistant.

12. The interactive program guide of claim 1 including at least one pictorial icon displayed on said menu that is not associated with said programming content.

13. The interactive programming guide of claim 1, wherein at least one of the plurality of the pictorial icons is a graphical image of a character from programming content associated with the at least one of the plurality of the pictorial icons.

14. The interactive programming guide of claim 1, wherein at least one of the plurality of the pictorial icons is a graphical image of a scene from programming content associated with the at least one of the plurality of the pictorial icons.

15. The interactive programming guide of claim 1, wherein at least one of the plurality of the pictorial icons is a graphical image of an item from programming content associated with the at least one of the plurality of the pictorial icons.

16. The interactive program guide of claim 1, wherein at least one of the plurality of the pictorial icons is a two dimensional graphical image.

17. The interactive programming guide of claim 1, wherein at least one of the plurality of the pictorial icons is a three dimensional graphical image.

18. The interactive programming guide of claim 1, further comprising a pictorial icon sizing module that changes the size of the at least one of the plurality of the pictorial icons with at least another one of the plurality of the pictorial icons.

19. The interactive programming guide of claim 13, wherein the pictorial icon sizing module displays a pictorial icon that is larger than at least one of the plurality of pictorial icons to indicate that the associated programming content is video on demand content.

20. The interactive programming guide of claim 14, wherein the pictorial icon sizing module displays a pictorial icon that is larger than at least one of the plurality of pictorial icons to indicate that the associated programming content is live programming content.

21. The interactive programming guide of claim 14, wherein the pictorial icon sizing module displays a pictorial icon that is larger than at least one of the plurality of pictorial icons to indicate that the associated programming content is a predetermined favorite.

22. The interactive programming guide of claim 1, further comprising a pictorial icon shaping module that changes the shape of the at least one of the plurality of the pictorial icons with at least another one of the plurality of the pictorial icons.

23. The interactive programming guide of claim 1, further comprising a pictorial icon coloring module that changes the color of the at least one of the plurality of the pictorial icons with at least another one of the plurality of the pictorial icons.

24. The interactive programming guide of claim 1, further comprising a pictorial icon forefront module that displays at least one of the plurality of the pictorial icons as being in the forefront of the display compared with at least another one of the plurality of the pictorial icons.

25. The interactive programming guide of claim 1, further comprising at least one button operably connected to the display that the user presses in order to make the menu selection.

26. The interactive programming guide of claim 1, further comprising a remote control that transmits a user input of the menu selection to the display.

27. An interactive programming guide, comprising:
a menu display module that displays a menu of a plurality of pictorial icons, wherein each of the plurality of pictorial icons is associated with a symbol in which a user identifies programming content;
a reception module that receives a menu selection from the user; and
a programming content selection module that displays on a display the programming content associated with the menu selection.

28. An interactive programming guide, comprising:
a menu display module that displays a menu of a plurality of pictorial icons, wherein each of the plurality of pictorial icons is associated with programming content;
an information request module that receives a request for information about the programming associated with one of the plurality of pictorial icons;
an information request answer module that provides the information about the programming associated with the one of the plurality of pictorial icons;
a reception module that receives a menu selection from the user; and
a programming content selection module that displays on a display the programming content associated with the menu selection.

29. The interactive programming guide of claim 28, wherein the information request answer module is a voice based response system.

30. An interactive programming guide comprising:
a menu display module that displays a plurality of user selectable programs;
said menu display module including at least one menu bar displaying available channels with pictorial icons associated with programs playing on said channels; and displaying a favorite character of a viewer to promote an upcoming program of interest to the viewer or to help a viewer who cannot read learn what content is available, both now playing and on demand.

31. The interactive programming guide of claim 30, wherein displaying said favorite character includes displaying said favorite character as a pop-up on the menu display module.

32. The interactive programming guide of claim 30, including the step of providing an audible message associated with said favorite character to vocally announce an upcoming program.

33. The interactive programming guide of claim 32, including the step of providing a text message associated with said favorite character announcing an upcoming program.

34. The interactive programming guide of claim 30, including the step of providing a text message associated with said favorite character announcing an upcoming program.

35. The interactive programming guide of claim 30, wherein the step of displaying said favorite character includes the step of displaying said character as sitting on top of one of said at least one menu bar.

36. An interactive programming guide comprising:
a menu display module that displays a plurality of user selectable programs; and
said menu display module including at least one menu bar displaying available channels with pictorial icons associated with programs playing on said channels, said guide presenting said programs and said menu bar in a setting familiar to the user.

37. An interactive programming guide comprising:
a menu display module that displays a plurality of user selectable programs; and
said menu display module including at least one menu bar displaying available channels with pictorial icons associated with programs playing on said channels, said guide presenting said programs and said menu bar in a setting familiar to the user.

38. An interactive programming guide comprising:
a menu display module that displays a plurality of user selectable programs; and
said menu display module including at least one menu bar displaying available channels with pictorial icons associated with programs playing on said channels, and displaying a character to promote an upcoming program of interest to the viewer or to help a viewer who cannot read learn what content is available, both now and playing on demand.

39. The interactive programming guide of claim 38, wherein said icon promoting said program is a character associated with one of said programs.

40. The interactive programming guide of claim 38, wherein said character orally promotes said program.

41. The interactive programming guide of claim 38, wherein text messages are associated with said character to promote said program.

42. An interactive programming guide, comprising:
a menu display module that displays a menu of a plurality of pictorial icons, wherein certain ones of the plurality of pictorial icons are associated with programming content;
a reception module that receives a menu selection from the user; and
a programming content selection module that displays on a display the programming content associated with the menu selection, said programming guide including network promotional space on said display displaying information to said user in the form of text, graphics, video and/or audio.

43. The interactive programming guide of claim 42, wherein said information is based on the user's previous selections.

44. The interactive programmer, guide of claim 42, wherein the user is the viewer of said content and said information is based on input from said user.

45. The interactive programming guide of claim 42, wherein the user is the parent or guardian of said user and said information is based on input from said parent or guardian.

46. The interactive programming guide of claim 42, wherein said information includes programming that said network wishes to promote.

47. An interactive programming guide, comprising:
a menu display module that displays a menu of a plurality of pictorial icons, wherein certain ones of the plurality of pictorial icons are associated with programming content;
a reception module that receives a menu selection from the user; and
a programming content selection module that displays on a display the programming content associated with the menu selection, said module also displaying on-demand content along with said programming content.

48. The interactive programming guide of claim 47, wherein either said programming content or on-demand content which includes games.

49. The interactive programming guide of claim 47, wherein said on-demand content includes music.

50. The interactive programming guide of claim 47, wherein said on-demand content includes e-books.

51. An interactive programming guide, comprising:
a menu display module that displays a physical space familiar to a child having a plurality of pictorial icons therein, wherein certain ones of the plurality of pictorial icons are associated with programming content;
a reception module that receives a menu selection from the user; and
a programming content selection module that displays on a display the programming content associated with the menu selection.
